(19) United States
(12) Patent Application Publication
(10) Pub. No.: US 2005/0234957 A1
(43) Pub. Date: Oct. 20, 2005

(54) System for visualization and modification of a domain model

(76) Inventors: Michael Christopher Olson, Erie, CO (US); Uchenna Gerald Ogbuji, Superior, CO (US); Jeremy James Kloth, Longmont, CO (US)

Correspondence Address: OPPEDAHL AND LARSON LLP, P O BOX 5068, DILLON, CO, 80435-5068, US

(21) Appl. No.: 11/106,921

(22) Filed: Apr. 15, 2005

Related U.S. Application Data
(60) Provisional application No. 60/562,579, filed on Apr. 15, 2004.
(60) Provisional application No. 60/659,842, filed on Mar. 8, 2005.

(51) Int. Cl. G06F 17/00

(52) U.S. Cl. 707/101

(57) ABSTRACT

Viewing of representations of a portion of the domain model is permitted, based on simple criteria, with those representations reflecting the application of all rules within the domain model, and translating all manipulations of the representation back to corresponding alterations of the domain model, triggering further changes based on domain rules.

### CROSS-REFERENCE TO RELATED APPLICATIONS

This application claims the benefit of U.S. Application No. 60/562,579 filed Apr. 15, 2004 and U.S. Application No. 60,659,842 filed Mar. 8, 2005, both of which applications are hereby incorporated herein by reference for all purposes.

### BACKGROUND

The relational database model defines a very simple means for expressing rich relationships. The relational model, the theory behind relational database management systems (RDBMS) is rarely implemented; what people think of as relational database technology is really a weak version of the relational model, as defined in the ANSI/ISO structured query language (SQL) specifications. The weakness of SQL for domain models has resulted in well-known limitations in the information models used in many applications. Most real world problem spaces have some of the structure required by traditional database technology, but also significant elements that do not fit into this structure, requiring significant programmer effort to complete the model in the application. This results in a problem that has been called the “programming crisis”, in which the amount of work required to be performed by software developers greatly exceeds available software development resources. This problem has brought about many inventions and general technological developments. From the object-oriented model emerged the discipline of object-oriented DBMS (OODBMS). The idea of OODBMS was to improve flexibility in the domain model and database layers by introducing some of the popular conventions in programming languages. In practice, the gains in flexibility and expression proved too slight for any significant adoption. It would take an entirely new approach towards modeling of semi-structured data before significant gains were possible.

The World Wide Web Consortium (W3C), the organization behind technologies for content on the Web, has developed a set of languages to complement XML in providing for semi-structured graphs and hierarchies. The core is Resource Description Framework (RDF), which allows one to define a very simple set of logical assertions, and can be visualized as a directed labeled graph data structure. Graphs are among the most general and flexible data structures in computer science, and support semi-structured data quite well. Domain models can be expressed using a directed labeled graph data structure. As such, RDF is suitable for domain models that include semi-structured data. A language that builds on RDF, called Web Ontology Language (OWL), allows one to define declarative rules that govern the basic data, including many of the sorts of rules that govern typical domain models. RDF and OWL are called Semantic Web technologies, named after the W3C initiative for using extensible domain models to improve information management on the Web. OWL is based on an earlier technology known as Defense Advanced Research Projects Agency (DARPA) Agent Markup Language and Ontology Inferencing Language (DAML+OIL). All of these are based on knowledge-representation languages such as Conceptual Graphs, which are well known in computer science.

Semantic Web technologies offer solutions to domain modeling limitations, but at a very low level that requires considerable attention and expertise to translate into applications that are accessible to non-technical users. There are many commercial applications that provide facilities for management of and access to domain models based on Semantic Web technologies and similar technologies. All of them operate at a very low level and provide very weak means of connecting domain models to accessible user interfaces.

The languages of Semantic Web technology are what are known as specification languages. A specification language is a formal language used to express a domain model, almost exclusively in systems analysis and design, as contrasted with programming languages, which are used to implement the systems being designed. A specification language describes the system at a much higher level than a programming language, and in the traditional software development life-cycle specifications were translated into executable code by imposing the limitations of the programming model upon the domain model. There has been a lot of interest in bridging the gap between specification languages and programming languages, with varying results. Some of the shortcomings of this work have come from limitations in the specification languages themselves, and some have come from limitations in the implementations thereof.

Fourth-generation programming languages (4GLs) are a well-known example of this phenomenon. They are supposed to combine the domain modeling abilities of specification languages with the executable properties of programming languages. They were the basis of a large class of commercial products in the 1980s (and to some extent products that are still in use and development more currently). They were designed to mitigate the programming crisis by reducing the cost and effort required for programming. The idea was that 4GLs could help automate the transition from design to implementation. They are known for mixed success in their results, but more importantly, they operate under very different mechanisms then that of the system of the invention. The term “4GL” has been used very broadly, and in fact even SQL itself is called a 4GL, but the most relevant instances of 4GL for comparison to the system of the invention have gone as far as supporting automatic generation of whole systems from the output of Computer-aided software engineering (CASE) tools, including some integration of programming language, where necessary.

The specification conventions on which 4GLs are based do not support the inferencing and rich classification capabilities that Semantic Web technologies enable. Much of the practical problems in 4GLs stem from the weakness of expression of domain models they govern. This reduces the degree of programming automation provided by 4GLs. As an example, the domain models supported by 4GLs only allowed limited facilities for expressing domain rules that characterize many real-world problem statements. This increases the amount of specialized programming code required in order to complete the semantics of the application.

The current state of the art is that there are technologies that enable the use of domain models as the direct basis for application interfaces, but they do not provide for the richness of domain models provided for in Semantic Web technologies. On the other hand there are implementations of Semantic Web technologies which do provide for such rich expression, but do not provide for immediate implementation in user applications. There would be a great deal of practical value in any system that would combine Semantic Web technologies with extensibility to other systems for domain models and with the ability to make rapid connections between the domain model and the application layer of software.

### SUMMARY

The system of the invention provides a means for taking advantage of Semantic Web technologies for domain modeling, without having to put a lot of resources into specialized application logic to expose these models in user-friendly applications. It defines a very rich mapping from the domain model to a simplified representation for user access and manipulation. It enforces all the domain rules defined in the domain model and actually uses these domain rules and additional domain rules to drive its operation. It allows user manipulations in the simplified representation to be reflected in the domain model according to all the domain rules. In this way it supports not only the rapid development of rich applications, but also the inexpensive integration of multiple applications, which has always been a risky and expensive undertaking in computer engineering. The invention addresses the problem of programming crisis discussed in the background section.

A unique quality of the invention lies in its close and immediate integration of Semantic Web technology with familiar user interface patterns, as well as its ability to integrate with systems that use different methodologies for their domain models. Other inventions designed for the Semantic Web have not achieved such a rich integration with general application interface conventions, or have not been as flexible in their support for diverse methodologies of domain models.

An important achievement of the system of the current invention is the way in which it bridges specification language to programming language, and in many cases eliminates the need for programming language altogether.

The system of the invention provides for domain rule expression that obviates the need for specialized programming code concerned with the implementation of those semantics. The concept of bridging the gap from domain model to application interface is common to both 4GLs and the system of the invention, but the latter brings the important distinction of supporting semi-structured data models and rich domain rules, and uses these facilities as the foundation of its operation. This greatly improves the ability of designers to help automate and even obviate common programming tasks during implementation.

The system of the invention uses unique and original techniques to combine Semantic Web technologies with extensibility to other systems for domain models and with the ability to make rapid connections between the domain model and the application layer of software. This allows for much less expensive software development life-cycles than possible in the past.

### BRIEF DESCRIPTION OF THE DRAWINGS

FIG. 1 is an overview of one embodiment of the system of the invention.

FIG. 2 is an expanded view of one embodiment of the invention.

FIG. 3 is an illustration of part of an exemplary domain model that represents people in an organization.

FIG. 4 is an illustration of the resulting changes to FIG. 3's domain model.

FIG. 5 is a screen shot of an exemplary representation of the dynamic taxonomy used by User 1 in the Example before any changes are made to the domain model.

FIG. 6 is a screen shot of an exemplary representation of the dynamic taxonomy with the nodes Hamlet and MacBeth expanded.

FIG. 7 illustrates exemplary top level menu items for modification of the dynamic taxonomy.

FIG. 8 illustrates exemplary context sensitive menu items for modification.

FIG. 9 is an illustration of one embodiment of the invention which uses shared domain rules and grafted dynamic taxonomies.

FIG. 10 is a screen shot of an exemplary representation of the dynamic taxonomy used by User 2 in the Example before changes.

FIG. 11 is a screen shot of an exemplary representation of the dynamic taxonomy for User 2 after change has been applied but domain rules have not been applied.

FIG. 12 is a screen shot of an exemplary representation of the dynamic taxonomy after domain rules have been applied to User 2 changes.

FIG. 13 is a screen shot of an exemplary representation of the dynamic taxonomy for User 1 after changes have been applied by User 2.

FIG. 14 is a sequence diagram for Example 1.

FIG. 15 is a sequence diagram for the notification portion of Example 1.

### DETAILED DESCRIPTION

### Overview

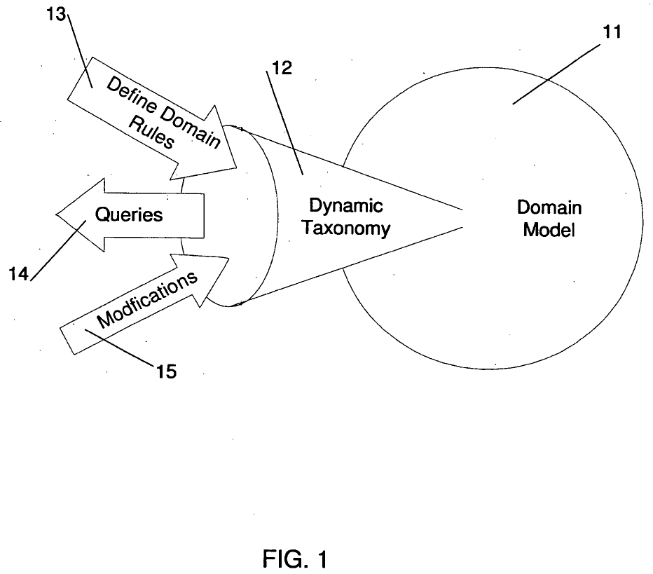

FIG. 1 is an overview of one embodiment of the system of the invention. The three major components are:
The Domain Model (11)
The Dynamic Taxonomy (12), and
The Representation (13, 14, and 15).
   Domain Model

The first component is the domain model. In the field of the invention, a domain model is expressed in a specification language, as described in the background section. A form of domain model focusing on the shared meaning of terms is referred to as an ontology. A directed labeled graph can be used to express a domain model, including an ontology. In the invention domain models are stored using a persistence engine capable of storing all of the information. The invention can store multiple domain models simultaneously, and can be used to unify them so that they can be manipulated as a single, combined domain model. Domain models are used to store all of the information for the system.

This information includes:
the data that the application uses,
all domain rules defined in the system,
and the domain rules that govern the dynamic taxonomies.

The purpose of the invention is to be able to query and modify the data stored in the domain model. The quantity of the data able to be queried and modified is often massive. This results in a potential problem for users of prior-art systems to be overwhelmed with information. The methods of the current invention for organizing and filtering the information in the domain model simplifies the process of finding and modifying data in the domain model for users. With the information organized and filtered, users can be presented with a common representation, no matter how the information is organized or filtered.

In addition to storing the data for an application, the domain model of the invention stores global domain rules that govern that application.

Exemplary contents of a domain model may include: properties, resources, literals, and statements.

Semantics of the Domain Model

The system of the invention can operate on many specification languages, but its primary domain model is founded on RDF and OWL, and the semantics of RDF and OWL are essential components of its operation. These semantics are defined by the W3C Semantic Web Activity working groups in the form of the following documents, which are incorporated into this document by reference.
“RDF: Concepts and Abstract Syntax” (http://www.w3.org/TR/rdf-concepts/) “RDF Semantics” (http://www.w3.org/TR/rdf-mt/)
“OWL Web Ontology Language Reference” (http://www.w3.org/TR/owl-ref/)
“OWL Web Ontology Language Semantics and Abstract Syntax” (http://www.w3.org/TR/owl-absyn/)

Below are definitions of some of the terms particularly used in this detailed description.

Resource (also “entity” and also “node”). Anything in the universe of discourse. Any thing that can be described.

Relationship (also “association”). Any conceptual connection between two or more resources.

Predicate (also “property”). Most basic form of relationship in the domain model. A labeled connection originating at one resource and terminating at one resource or one literal.

Class. A resource used to organize other resources by specifying predicates and domain rules that can be applied to those resource.

Instance. A resource that belongs to a specific class.

Domain. A class the instances of which are valid origination points for a particular predicate.

Range. A class the instances of which are valid termination points for a particular predicate.

Literals. An unnamed value of a property. A simple data type such as strings or numbers used to characterize resources according to a certain predicate.

Dynamic Taxonomy

The second major component of the invention is the dynamic taxonomy. The dynamic taxonomy represents a set of specialized domain rules that are used to filter and organize information in the domain model. The dynamic taxonomy performs the filtering and organization of the information bi-directionally. The term bi-directionally means that both queries through the dynamic taxonomy, and modifications through the dynamic taxonomy, utilize the set of specialized domain rules. This allows the user of the invention to create a customized view of the domain model. The user can then query and modify the customized view, allowing the dynamic taxonomy to translate all of the operations into queries and modifications in the actual domain model.

The actual creation of the dynamic taxonomy occurs when all of the domain rules have been defined, are grouped together, validated for logical consistency, and are stored in the domain model.

Stated differently, a dynamic taxonomy may be defied by the following steps. At least one domain rule is defined. One or more domain rules define how a domain model is filtered and transformed. One or more domain rules are validated to insure that they are logically consistent with other rules or within themselves. One or more domain rules are persisted into a domain model. The domain rules may be defined by human users; other systems, or other appropriate means.

Once a dynamic taxonomy has been created and stored in the domain model, it can be used repeatedly to perform any and all of the following operations:
query information through the dynamic taxonomy
modify information through the dynamic taxonomy
change the domain rules that define the dynamic taxonomy

It is important to note that the these operations can be performed repeatedly, and in any order.

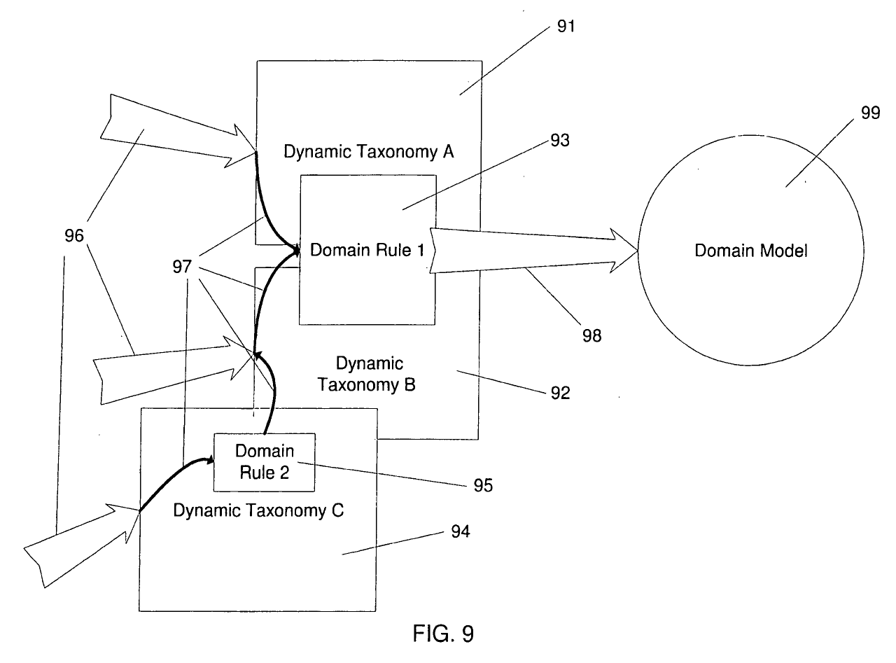

One aspect of this invention to note is that domain rules can be shared between dynamic taxonomies. This allows for expressing domain wide rules that can be further customized by individual dynamic taxonomies. This promotes greater information sharing within the domain model, and increases the effectiveness of the invention by further reducing the overhead needed to visualize and manage information. FIG. 9 shows a graphical representation of how domain rules (93 and 95) are shared between dynamic taxonomies. In FIG. 9, we see that information flowing through both dynamic taxonomy “A” (91) and dynamic taxonomy “B” (92) pass through the common domain rule “1” (93). Both dynamic taxonomy “A” and dynamic taxonomy “B” would be allowed to have additional domain rules if needed.

In addition, a dynamic taxonomy as a whole can be used as a domain rule in other dynamic taxonomies. This conceptually allows for the grafting of taxonomies, allowing users of the system to visualize even more complicated domain rules in a simple fashion. FIG. 9 shows a graphical representation of this. In FIG. 9 we see that information that flows through the dynamic taxonomy “C” (94) is first transformed by any domain rules in this dynamic taxonomy, in this case domain rule 2 (95), is then passed on to dynamic taxonomy “B” (92), where it is further transformed by the domain rules of this dynamic taxonomy, in this case domain rule “1” (93).

In FIG. 9, the external information flowing into and out of the dynamic taxonomies is illustrated by the large arrows (96) and the information flowing through the dynamic taxonomies is illustrated by the small arrows (97). Arrow 98 represents information flowing into or out of the domain model (99).

To make the previous points in a different way, one embodiment of the invention is a method for managing information in a domain model. This method comprises the following steps. At least a first and second domain rule is utilized to define a first dynamic taxonomy. At least a first and third domain rule is utilized to define a second dynamic taxonomy. The first and second domain rules do not result in the same transformation. The second and third domain rules do not result in the same transformation. The first and third domain rules also do not result in the same transformation. Information is extracted from the domain model through the first dynamic taxonomy. Information is extracted from the domain model through the second dynamic taxonomy. In addition, some or all of the domain model may be modified by making changes through the first dynamic taxonomy, and or through the second dynamic taxonomy.

Exemplary steps of the method of the invention may also include the following. At least one domain rule is used to define a first dynamic taxonomy. Information is extracted from the domain model through the that dynamic taxonomy. At least one more domain rule is utilized together with the dynamic taxonomy defined with the first domain rule or rules to define a second dynamic taxonomy. Information is extracted from the domain model through the first and second dynamic taxonomies.

Additionally, other exemplary steps of the method of the invention may include the following. At least one domain rule is used to define a first dynamic taxonomy. Some or all of the domain model is modified by making changes through that first dynamic taxonomy. At least one more domain rule is utilized together with the dynamic taxonomy to define a second dynamic taxonomy. All or some of the domain model is modified by making changes through the second dynamic taxonomy.

External Represention of Data

The third major component of the invention is the external representation of the data that passes through the dynamic taxonomy. This representation includes but is not limited to:
A common programming API which allows custom clients to access the information.
A graphical interface for representing the taxonomy information in a tree or other suitable format.

A representation requires that queries and modifications to a dynamic taxonomy allow the same set of queries and modifications regardless of the domain rules used to define the dynamic taxonomy. With this common representation, users of the invention can be classified into two sets of users. The first are users that have an understanding of the domain model and the domain rules that define and constrain the domain model. These users use various means to create and manage the domain rules that govern various dynamic taxonomies. The second set of users have little or no knowledge of the domain model and domain rules. These users use the representations of the dynamic taxonomy to manage information in the domain model. Put simply, this group of users are tasked with managing a tree of information. Without knowledge of the underling domain model, the users are able to organize the tree of information. The dynamic taxonomies in this invention then manage the translation of information. Through this, a user of the dynamic taxonomy can manage the domain model, but is not required to have knowledge of the domain model itself.

It should be appreciated that in various embodiments of the invention, GUIs or APIs may be utilized to extract information from the domain model. In addition, GUIs or APIs may be used to view representations of the information extracted through dynamic taxonomies.

A metaphoric example of a representation is a file system in an operating system. A user of the file system in a windowed environment can move files and folders around in the file system. The operating system then translates these operations into operations that modify the physical storage system such as a hard drive, or a USB flash drive. The user does not need to understand how these physical storage devices work, just that they are tasked with managing the tree of information that is represented as files and folders in the graphical operating system. It should, however, be kept in mind, that the invention of this application is not the same as the methods used to manage the file system of an operating system. The most important difference is that in file system user interfaces, the nodes have very specific and limited semantics tied to the corresponding files. In the invention, the nodes are abstractions that can take on any semantics that can be defined in the domain model, which could be files, but could also be anything else that can be formally conceptualized.

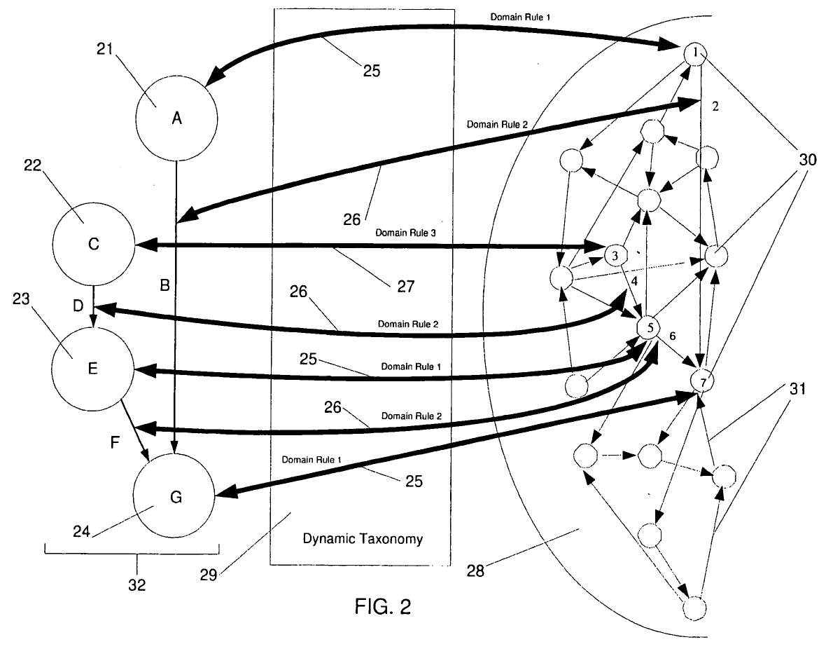

FIG. 2 is an expanded view of one embodiment of the invention. FIG. 2 illustrates a domain model (28) which contains an undetermined number of resources (30) and relationships (31) between resources. On the left side of the figure, a representation (32) of the transformed resources and relationships is illustrated. FIG. 2 also shows a dynamic taxonomy (29) which is represented by the rectangle. As stated above, within a dynamic taxonomy one or more domain rules are defined. In FIG. 2, there are three domain rules (25, 26, and 27) defined. The details on the transformations are further defined below. The invention puts no limitations or restrictions on the number of domain rules in the dynamic taxonomy, nor how they domain rules transform and filter relationships and resources. That is with the exception of the requirement to have at least one domain rule to define the taxonomy. It is very common to have a single domain rule that transforms both relationships and resources in a dynamic taxonomy.

Query

When a query is made through the dynamic taxonomy, the domain rules are applied to the query. Using FIG. 2 as an example: if a query is made regarding resource “A” (21) in the transformed view (32) (the representation), then the dynamic taxonomy (29) translates this, using Domain Rule 1 (25), into a query for resource “1” in the domain model (28). Similarly, when a query is made in regards to property “B” in the transformed view, the dynamic taxonomy (29) translates this, using the Domain Rule 2 (26), into a query about property “2”.

Modification

Similar to the translations that occur when a query is made, they also occur when a modification is made. Again using FIG. 2 as an example: when a request is made to remove the relationship “D” between resources “C” (22) and “E” (23), the dynamic taxonomy (29), using Domain Rules 1, 2, and 3 (25, 26, and 27), translates this into a request to remove relationship “4” between resources “3” and “5”.

The following text is a more specific description of FIG. 2 as a whole. Domain Rule 1 (25) is defined as a transformation on a set of resources which include the resources with the numbers 1, 5, and 7 in the domain model and are represented by the circle with the A (21), the circle with the E (28), and the circle with the G (24) in the representation (36). Domain Rule 2 (26) is a transformation on a set of relationships which include the relationships with the numbers 2, 4, and 6 in the domain model and are represented by the lines of B, D, and F in the representation (32), and Domain Rule 3 (27) is a transformation on an additional set of resources which includes the resource with the number 3 in the domain model and the circle with the C (22) in the representation.

Notification

Whenever changes are made to the model, ether by direct user action or by the resulting action of domain rules, the system of the invention sends notification of these changes in the form of computer messages to any party that has registered to receive such notifications. As an example, if the user causes a property of a resource to change through a dynamic taxonomy, the system of the invention will send notifications to all registered parties of this change. If the change of this property causes an actuation of domain rules so that the resource is now of a new class, the system of the invention will send notifications to all registered parties of this change. These notifications can be used to connect external software systems to the dynamic taxonomy.

The operation of the invention may be more clearly understood through a simple example of its use in a typical application context.

### EXAMPLE 1

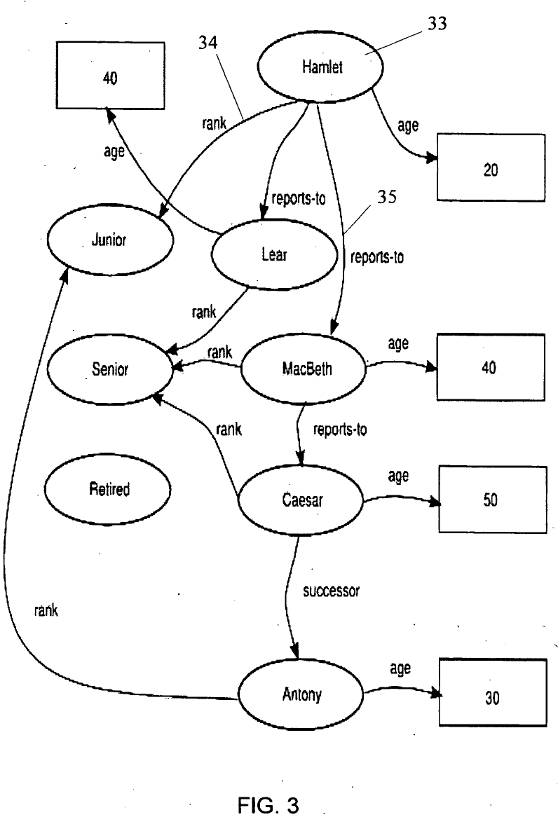

FIG. 3 illustrates part of a very simple domain model that represents people in an organization. It is a collection of information, which, though all related, encompasses several contexts that users would typically prefer to work with separately.

This example is simple, for purposes of illustration, but in actual uses of the invention such models would include thousands or millions of nodes and relationships. FIG. 3 does not display the domain rules within the model, for simplicity of the illustration. However in actual use the domain rules are stored in the same model as the data shown in FIG. 3. The domain rules for the example are defined as follows:
Rule 1: A person is the origin of only one “ranks” relationship
Rule 2: A person is the origin of only one “successor” relationship
Rule 3: A person is the origin of only one “age” relationship
Rule 4: All “reports-to” relationships from a person with a “rank” of “Retired” are forwarded to the person designated as a “successor”
Rule 5: A person pointed to in a “reports-to” relationship has a rank of “Senior”

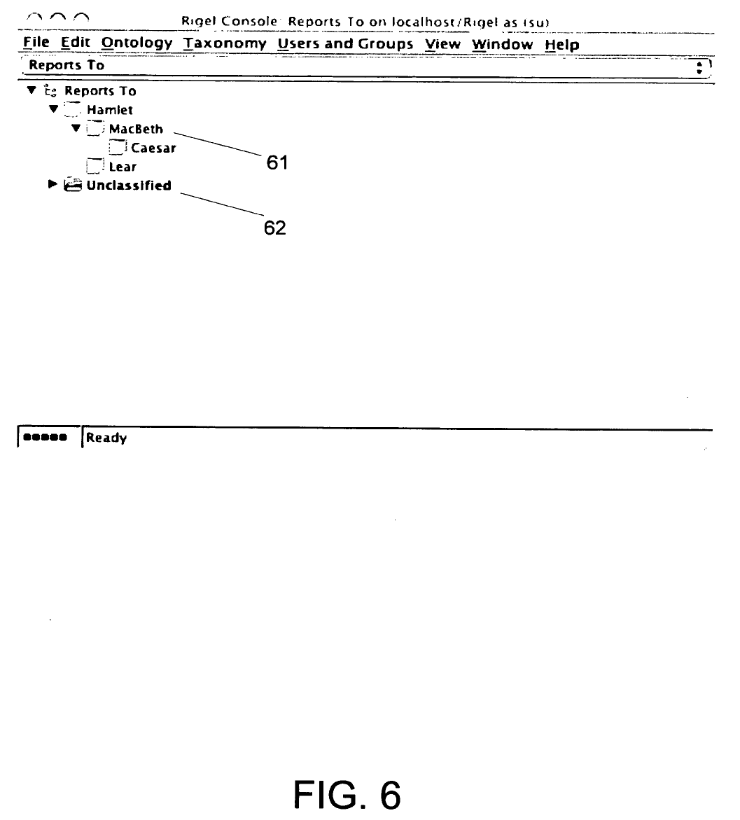

The first user (“User 1”) in the example scenario is only concerned with the reporting relationship within the organization and would create a dynamic taxonomy that filters and organizes information based on the “reports-to” property (35). Using the invention, and starting with the model in FIG. 3 and the domain rules, User 1 would see a representation of such information as shown in FIG. 6.

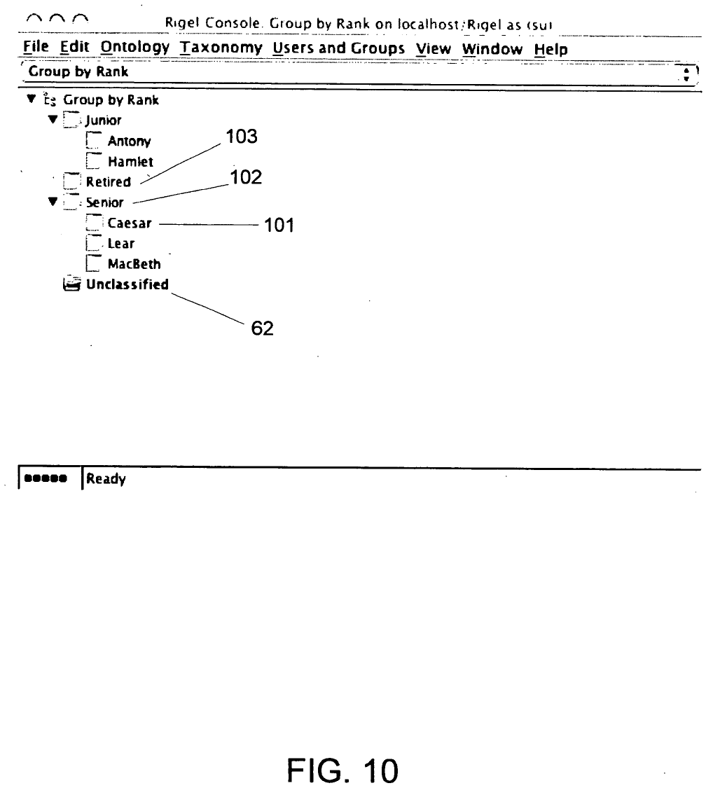

The second user (“User 2”) is concerned with recording the rank of each person within the organization. Thus, User 2 would define a dynamic taxonomy that organizes and filters information based on the “rank” property (34). Using the invention, and starting with the model in FIG. 3, and the domain rules, User 2 would see a representation of such information as shown in FIG. 10.

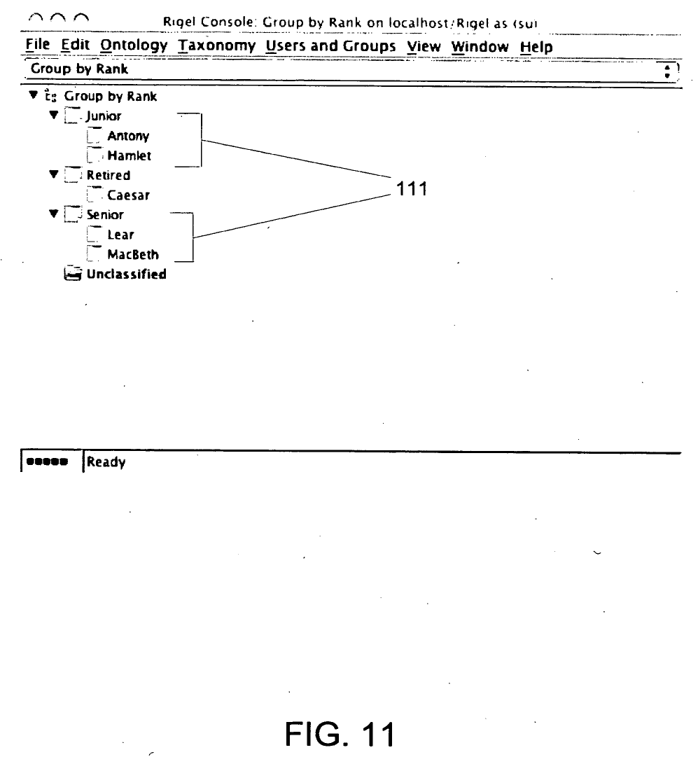

Notice that both users are seeing simplified representations of the overall information model illustrated in FIG. 3. The invention allows a great deal of flexibility and application of domain rules into the process of simplification, but this facility is just part of the invention. In one embodiment of the invention, User 2 can use the tree structure illustrated in FIG. 10 to make the simple adjustment of moving “Caesar” (101) from the “Senior” section (102) to the “Retired” section (103) using any means available through the representation. This would result in an evanescent state (111) such as that shown in FIG. 11. Because this is an intermediate state, neither User 1 or User 2 would receive notification, at this point in time, of changes to their representations. Notification of changes is performed after all domain rules have been processed.

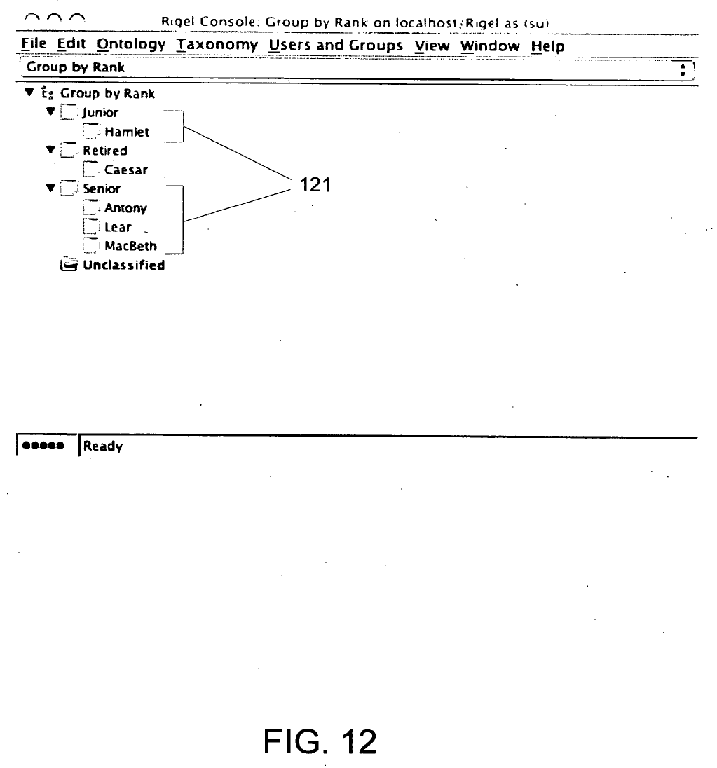

The invention would then cause immediate, additional changes based on the domain rules defined in the domain model. Domain rule 4 would result in the movement of the “reports-to” relationship from “MacBeth”, pointing to “Caesar”, instead pointing to “Antony”. This would be immediately actuated even though “reports-to” relationships are not part of the representation being used by User 2. As a result, domain rule 5 would come into effect, promoting “Antony” from “Junior” to “Senior” rank, and the resulting representation (121) User 2 would actually see from their manipulation is shown in FIG. 12. User 2's representation (121) would not need to query the domain model to determine these changes. Instead, the domain model would send notification to all interested listeners, not just User 2's representation. This would be notification that changes to the dynamic taxonomy have occurred. The changes would be sent as notification using the following set of events:
1. Remove the child “Caesar” from the parent “Senior”
2. Add the child “Caesar” to the parent “Retired”
3. Remove the child “Antony” from the parent “Junior”
4. Add the child “Antony” to the parent “Senior”

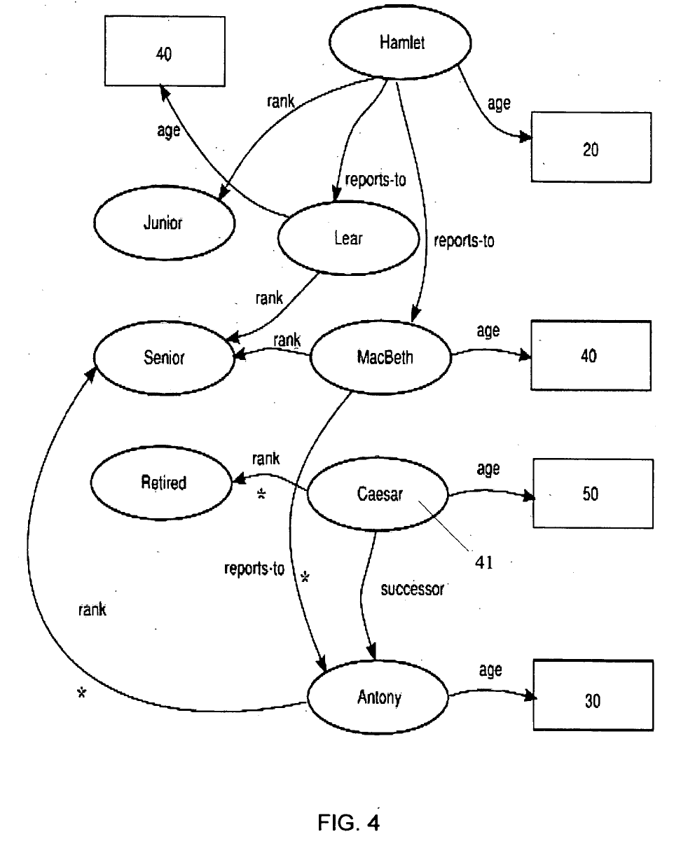

The resulting changes in the domain model are reflected in FIG. 4. The changed relationships are marked with an asterisk, for clarity.

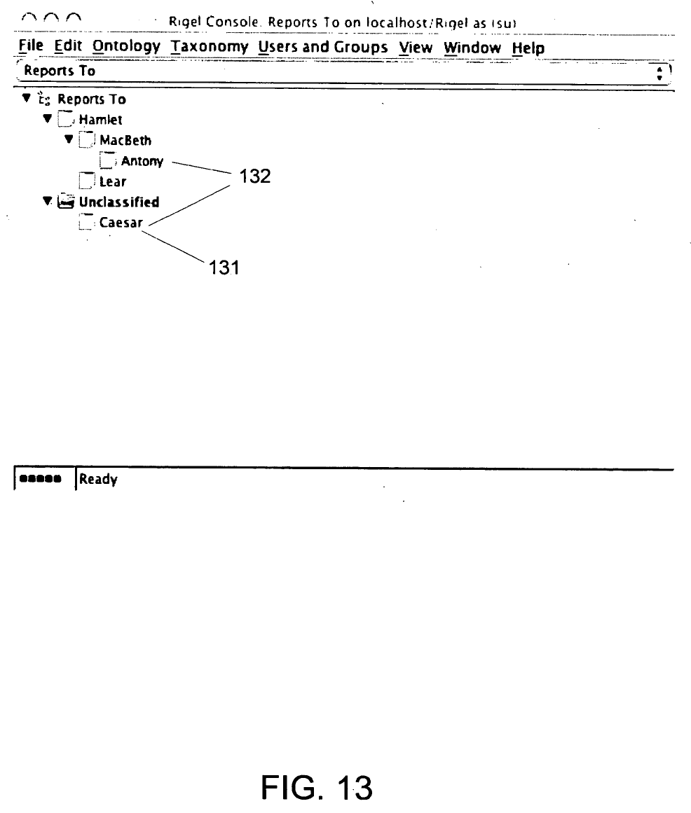

User 1 would also see the effects of these changes made by User 2. User 1's representation would be updated (1312) as shown in FIG. 13. Even though User 1 did not cause any changes to the domain model, the domain model would still send notification that the following changes have occurred to the dynamic taxonomy.
1. Remove child “Caesar” from the parent “MacBeth”.
2. Add an unclassified resource “Caesar”.
3. Remove the unclassified resource “Antony”.
4. Add child “Antony” to the parent “MacBeth”.

The seemingly simple change made by User 2, through application of the domain rules within the invention, results in potentially far-reaching changes within the domain model, which are reliably reflected even in seemingly unrelated representations of the model, as illustrated by FIG. 13.

### Technical Section

In an embodiment of the invention, when a dynamic taxonomy is created with a set of domain rules, or an existing dynamic taxonomy is modified with a new set of domain rules, the domain rules are used to create five OWL classes and two RDF properties. These seven components of a dynamic taxonomy then control the transformations that are performed by the dynamic taxonomy by providing common definitions of data sets in the domain model. These data sets are used by the dynamic taxonomy's logic to compute the answers to the common query interfaces, and perform the modifications in the common modification interfaces.

There is not a direct mapping from a domain rule to a component definition in a dynamic taxonomy. Instead, all of the domain rules are used together in the creation of these components. For example, a single domain rule can by used to create all seven dynamic taxonomy components. The only limitation placed on this by the invention is that the components must be created and the dynamic taxonomy as a whole must be logically consistent as defined below. It should also be noted, that while the classes are listed below in an order, it is not necessary to the invention to define them in that same order.

Member Class

The first of the classes created is called the member class. Any resource in the domain model that is an instance of a dynamic taxonomy's member class is a member of the dynamic taxonomy. Membership in a taxonomy defines the set of resources in the domain model that can be used for queries and modifications through the dynamic taxonomy.

The member class must also include the resource that represents the taxonomy itself. This is because the resource is considered a member of itself. The reasoning for this is defined below.

Node Class

The second class that must be defined by the domain rules is the node class. The node class defines the set of members of the dynamic taxonomy that have a parent. Generally, the node class is the intersection of the member class and all resources with one or more parent properties. However, the invention does not necessarily require implementation of the node class in this manner. The parent property is further defined below.

Container Class

The third class that must be defined by the domain rules is the container class. This class represents the set of members in the dynamic taxonomy that are allowed to have children. Children in the dynamic taxonomy are defined using the Child Property defined below. This set must also include the taxonomy itself because the taxonomy is also allowed to have children. This is why the member class must include the taxonomy itself as all containers must be members of the taxonomy.

Unclassified Class

The fourth class that must be defined by the domain rules is the unclassified class. This class represents all of the members of the taxonomy that do not have a parent. Generally, the unclassified class is implemented as the intersection of all resources in the member class, and all resources that have exactly zero parent properties. However, the invention does not necessarily require implementation of the unclassified class in this manner.

Root Child Class

The fifth and final class that must be defined by the domain rules is the root child class. This class defines all of the members of the taxonomy that are direct children of the taxonomy itself. All members of this class must also be members of the node class.

Child Property

The first property that must be defined by the dynamic taxonomy is the property that represents the child relationship, called the child property. This property is used to create the hierarchy in the taxonomy. The children of a resource are defined as all resources B such that child(resource,B) is true.

Parent Property

The second property is the property that defines the parent relationship, called the parent property. This property is typically the inverse of the child property however, it is not a requirement that it be so.

Logical Consistency

Once the classes and properties are defined, the dynamic taxonomy is validated for logical consistency. All of the following tests must pass, or the dynamic taxonomy (and associated domain rules) are not stored in the domain model.
5. The set of resources that defines the members of the taxonomy is equal to the union of the set of members in the node class, the set of members in the unclassified class and the taxonomy.
6. The set of resources that define the node class must be disjoint with the set of resources that define the unclassified class. Disjoint is defined as no resource can be a member of both classes.
3. Consider two relationships, child(A,B), meaning that resource A is a child of resource B, and parent(B,A), meaning that resource B is a parent of resource A. For all members in the taxonomy that can be substituted for A and B, both of those relationships must exist, or neither.
4. The domain of the child property is the container class.
5. The range of the child property is the member class.
6. The domain of the parent property is the member class.
7. The range of the parent property is the container class.
   Representations

Implementations of the invention are made accessible to users of the system through representations of the dynamic taxonomies. An exemplary representation is shown below and utilizes Java Swing technology for the graphical interface, and the PostgreSQL relational database for the persistence of the domain model. It should be noted that while this exemplary representation is used in this document for purposes of description, the invention may utilize any of a number of common representation methods for allowing access to the dynamic taxonomies. Those representations may include, but are not limited to utilizing HTML, XML, Server Side applications such as Java scriptlets, Microsoft Foundation Classes (MFC) or the Tk graphical library.

There have been other tools for developing representations of RDF and OWL domain models, including Stanford University's Protege and the University of Maryland's SWOOP. The system of the invention is quite different from these other tools in that it translates the domain model into a representation designed for immediate use by the end user, rather than by the RDF or OWL language or semantics expert. Doing so requires sophisticated advancement in using the domain rules themselves to drive the representation of the domain model in end-user friendly user interface metaphors, as shall be more closely explained in this section.

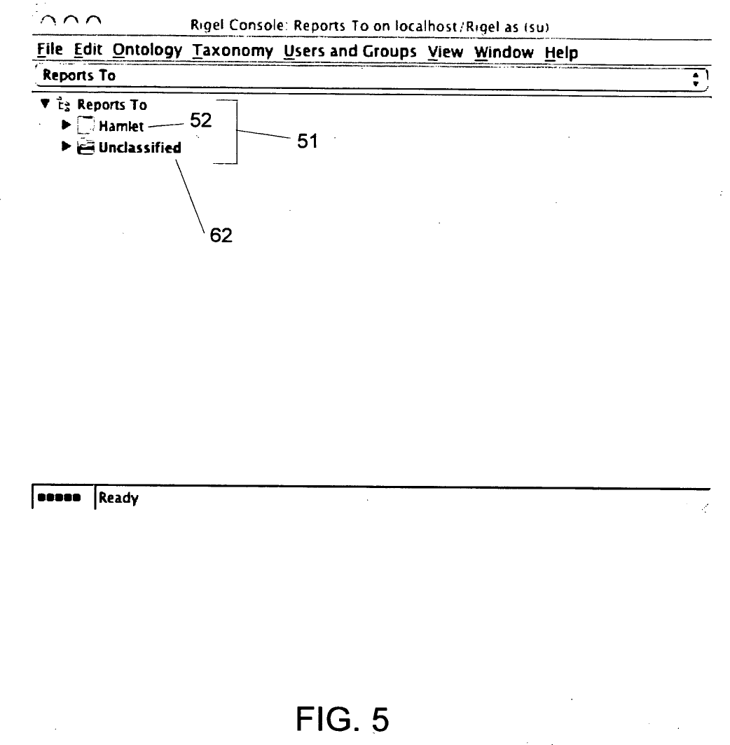

One example implementation of representation for the invention is written using Java Swing graphical user interface (GUI) library that allows visualization and management of information through dynamic taxonomies. FIG. 5 shows a screen shot of this example implementation displaying the dynamic taxonomy for User 1 from the example discussed above.

In this implementation, the dynamic taxonomy is represented as a tree (51). With the tree, a user can view the hierarchy of the dynamic taxonomy by expanding nodes at different levels of the tree. FIG. 6 shows the results of a user expanding the node MacBeth (61). Additionally, users can modify the tree using common GUI paradigms. For the representation to create the display, it uses the four of the seven components defined on the dynamic taxonomy. The first component used is the container class. This is used to determine if a node in the representation tree should be drawn with a folder icon next to it. To determine this, the example implementation performs a check to see if the resource being displayed is a member of the dynamic taxonomies container class. If the resource is, then a folder icon is displayed. If not, then additional logic is used to determine the icon which is not part of this invention.

The second component used is the child property. This property is used by the example representation to determine the children of a resource in a taxonomy. When a user makes a request to expand a node that is a member of the container class, then the example implementation requests all resources that are children of the requested resource and displays the children in the appropriate location of the tree. The exception to this is when the children of the dynamic taxonomy itself need to be displayed. In this case, the members of the “Root Child Class” are queried and these resources are displayed as the children of the dynamic taxonomy.

The last component used by the example implementation is the Unclassified Class. Members of this class are used to display children of the “Unclassified” folder (62) shown as the last child of the dynamic taxonomy in FIG. 5 and FIG. 6. This allows the user in the example implementation to see all of the resources in the dynamic taxonomy that do not have a parent relationship. See Caesar (131) in FIG. 13. These aspects of the example implementation show the common query interfaces into a dynamic taxonomy.

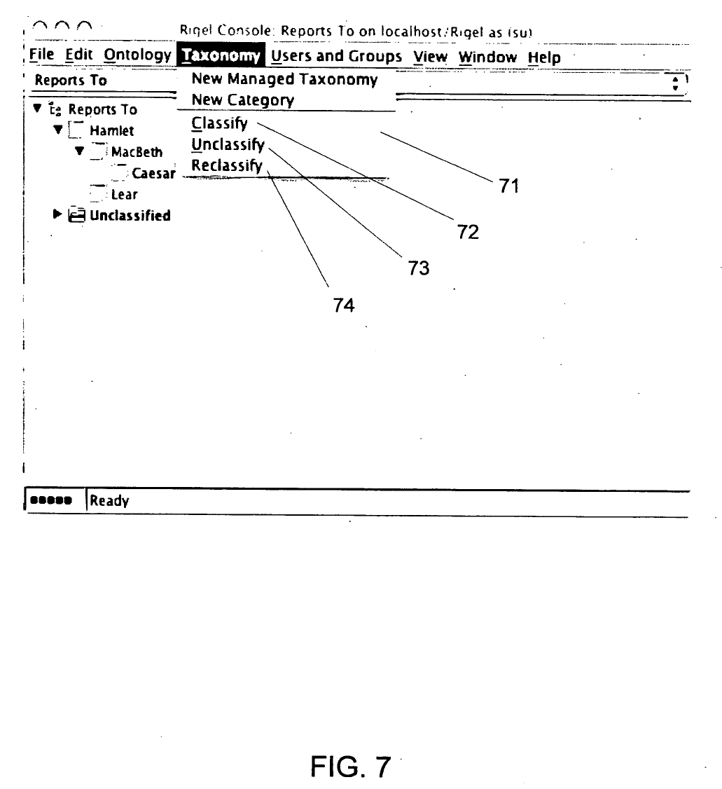

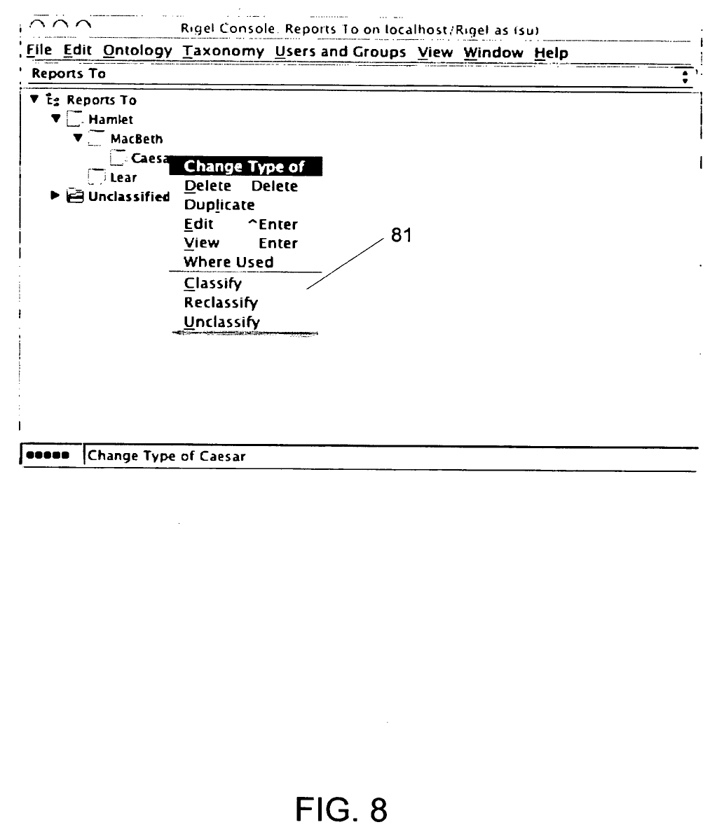

Common modifications of the dynamic taxonomy in this example implementation are performed with two different operations by the user. The first is through a set of menu options. These options are accessible through the top level menus (71), as shown in FIG. 7 and context sensitive menus (81) as shown in FIG. 8. The menu options can be used to perform the common dynamic taxonomy operations of classify (72), unclassify (73) and reclassify (74).

A second common method for modification may occur through the commonly known user interface paradigm of “Drag and Drop”. Using “Drag and Drop” a user can copy or move a resource from one location in the tree to a second location in the tree. This allows the user to perform the operations of classify and reclassify.

Notifications of changes in the dynamic taxonomy in this example implementation are provided using a well-known technique sometimes called the “observer pattern” or “publish/subscribe”. In this technique, an external computer system that needs to receive notations is known as the “consumer”. The consumer registers with the system, of the invention, which is called the “producer”. In normal usage the domain model changes through user interaction (such as the changing of “Caesar” to “Retired” rank) or through domain rules (Such as the promotion of “Antony” to “Senior” rank). When such changes occur the producer sends all of the registered consumers a computer message with details of the change that occurred in the domain model. The message detail encompasses all seven components of a dynamic taxonomy (described above), as well as, changes to the domain rules upon which the dynamic taxonomy is based.

### Technological Description of Example 1

The relevant, for the purpose of this description, schema definitions for the example are shown as OWL below. These definitions are assumed to be present in the domain model.

```
<owl:Class rdf:ID=“Person”>
  <owl:subClassOf>
    <owl:Restriction maxCardinality=“1”>
```

<owl:onProperty rdf:resource=“#rank”/>

```
    </owl:Restriction>
  </owl:subClassOf>
</owl:Class>
<owl:Class rdf:ID=“Rank”/>
<owl:ObjectProperty rdf:ID=“rank”>
  <rdfs:domain rdf:resource=“#Person”/>
  <rdfs:range rdf:resource=“#Rank”/>
</owl:ObjectProperty>
```

From these definitions, we see that domain rule 1 is satisfied in this schema by the definition of the class Person, by defining that the rank property is allowed on the class Person using the range property, that the rank property must reference an instance of Rank, and that a person is allowed to have at most one rank through the max cardinality restriction.

In the example described above, the domain rule used to create a dynamic taxonomy for User 2 is “group all people in the domain model by rank”. This domain rule translates into the following components in the dynamic taxonomy.

1) Member class: the union of all resources that are allowed to have the “rank” property, all resources that are allowed to have the rank property pointing to it, and the dynamic taxonomy. The OWL classes that implement this are shown below.

```
<owl:Class rdf:ID=“MemberClass”>
  <owl:unionOf rdf:parseType=“Collection”>
    <rdf:Description rdf:about=“#Person”/>
    <rdf:Description rdf:about=“#Rank”/>
    <owl:Class>
```

<owl:oneOf rdf:parseType=“Collection”>
<rdf:Description rdf:about=“#taxonomy”/>
</owl:oneOf>

```
    </owl:Class>
  </owl:unionOf>
</owl:Class>
```

2) Node Class: the intersection of the member class, and all resources that have 1 or more parent properties. The OWL for this class definition is shown below.

```
<owl:Class rdf:ID“NodeClass”>
  <owl:intersectionOf rdf:parseType=“Collection”>
    <rdf:Description rdf:about=“#MemberClass”/>
    <owl:Restriction minCardinality=“1”>
```

<owl:onProperty rdf:resource=“#parent”/>

```
    </owl:Restriction>
  </owl:intersectionOf>
</owl:Class>
```

3) Unclassified Class: the intersection of the member class, and all resources with exactly zero parent properties. The OWL for this class definition is shown below.

```
<owl:Class rdf:ID=“UnclassifiedClass”>
  <owl:intersectionOf rdf:parseType=“Collection”>
    <rdf:Description rdf:about=“#MemberClass”/>
    <owl:Restriction cardinality=“0”>
```

<owl:onProperty rdf:resource=“#parent”/>

```
    </owl:Restriction>
  </owl:intersectionOf>
</owl:Class>
```

4) Container Class: the intersection of the member class and the union of the taxonomy and all classes that can be pointed to by the “rank” property. The OWL for this class definition is shown below.

```
<owl:Class rdf:ID=“ContainerClass”>
  <owl:intersectionOf rdf:parseType=“Collection”>
    <rdf:Description rdf:about=“#MemberClass”/>
    <owl:Class>
```

<owl:unionOf rdf:parseType=“Collection”>
<owl:Class>

<owl:oneOf parseType=“Collection”>
<rdf:Description rdf:about=“#taxonomy”/>
</owl:oneOf>

```
  </owl:Class>
  <rdf:Description rdf:about=“#Rank”/>
</owl:unionOf>
```

```
    </owl:Class>
  </owl:intersectionOf>
</owl:Class>
```

5) Root Child Class: the intersection of the node class and all resources that can be pointed to by the rank property. The OWL for this class definition is shown below.

```
<owl:Class rdf:ID=“RootChildClass”>
  <owl:intersectionOf rdf:parseType=“Collection”>
    <rdf:Description rdf:about=“#NodeClass”/>
    <rdf:Description rdf:about=“#Rank”/>
  </owl:intersectionOf>
</owl:Class>
```

6) Child Property: the inverse of the parent property. The OWL for this property definition is shown below.

<owl:ObjectProperty rdf:ID=“parentProperty”>
<owl:inverseOf rdf:resource“#rank”/>
</owl:ObjectProperty>

7) Parent Property: is defined as the rank property and no additional OWL needs to be defined to support this.

With the classes properly defined and stored in the domain model, the following example queries can be performed.

| Action | Translated Action | Example results |
|---|---|---|
| Get all unclassified | All instances of the | None |
| resources | unclassified class | |
| Get the children of the | All instances of the root | The resources Senior, Junior |
| taxonomy | child class. | and Retired |
| Get the children of Retired | All resources that are the | The resource Caesar |
| | object of the child property | |
| | for the Retired resource. | |
| Classify “Antony” in | Add the child property from | Add the property rank |
| “Retired” | the parent to the child | (“Antony”, “Retired”) |

The second dynamic taxonomy created in the example is defined with the domain rule to organize information using the “reports-to” property. While a complete dissection of this dynamic taxonomy would show OWL classes similar in nature to the ones described above, it is worth noting that in this taxonomy there are indeed unclassified resources. FIG. 4 shows that the resource “Caesar” (41) does not have any “reports-to” properties after the changes have been fully applied. Because of this, FIG. 13 shows the resource “Caesar” (131) as an unclassified resource in the dynamic taxonomy that is driven by the “report-to” property.

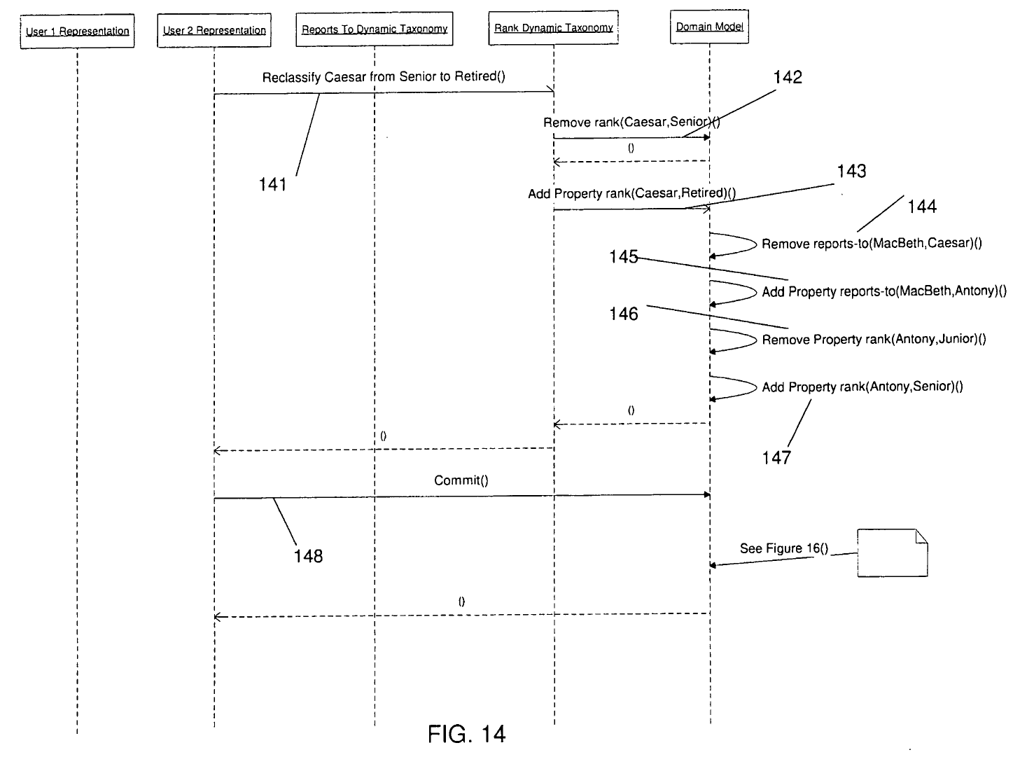

FIG. 14 shows a sequence diagram that encompasses the entire flow of operations through the invention for the example domain model and dynamic taxonomies. In it, we see that the initial request by User 2 to reclassify “Caesar” from “Senior” to “Retired” (141) first causes the property “rank” to be removed from the resource “Caesar” (142) and a new rank property to be added from “Caesar” to “Retired” (143). With the addition of the property, the domain model invokes Domain Rule 4. This causes the “report-to” property between “MacBeth” and “Caesar” (144) to be removed. Additionally, it causes a new “reports-to” relationship between “MacBeth” and “Antony” to be created (145). The addition of the new “reports-to” property triggers Domain Rule 5. This removes the “rank” property from “Antony” that referenced “Junior” (146) and adds a “rank” property from “Antony” to Senior” (147). At this point in the sequence diagram, flow returns to the “rank” dynamic taxonomy.

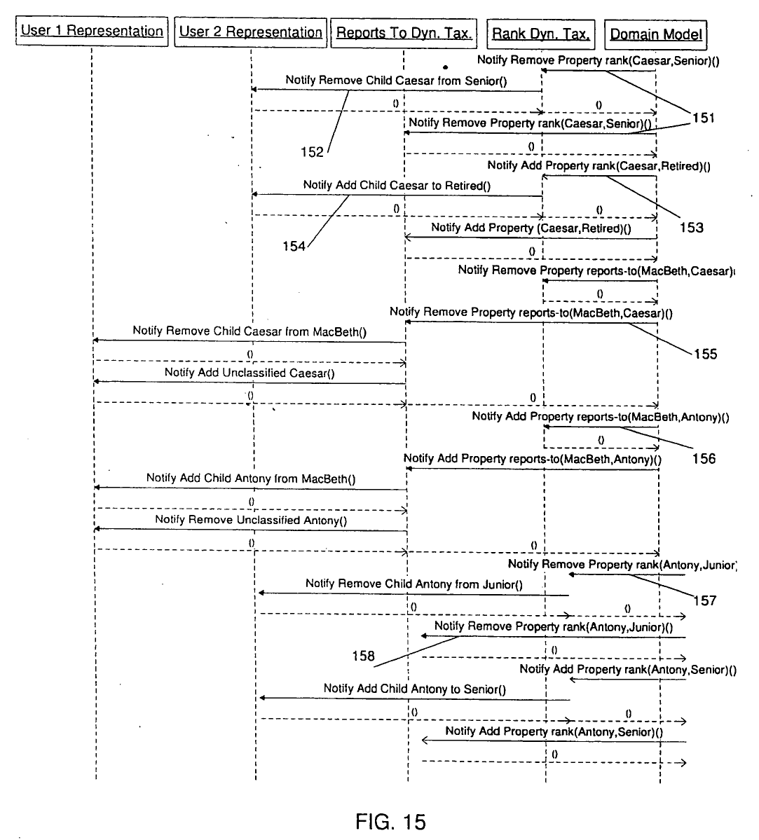

It is important to note that at this point in the sequence diagram, no notification has been sent to any listeners. Notifications are queued throughout processing until a successful transaction boundary is reached. In the case of our example, the “rank” dynamic taxonomy has completed all of its operations and invokes the standard transactional interface “commit” on the domain model (148). This causes the domain model to persist the requested changes and begin the notification process (illustrated in FIG. 15).

FIG. 15 shows the sequence of processing after commit has been called on the domain model. It should be noted that even though the sequence diagram has been broken into two separate figures (FIG. 14 and FIG. 15) for clarity, they both represent a single sequence of events. In the example, the domain model first notifies all listeners of the removal of the property “rank” from the resource “Caesar” to the resource “Senior” (151). The “reports-to” dynamic taxonomy is not interested in changes to the “rank” property and does no further processing of this event. However, the “rank” dynamic taxonomy is interested in changes to the “rank” property and sends an event, over the common dynamic taxonomy notification event system, that the child “Caesar” has been removed from the parent “Senior” (152). Similarly, when the domain model next sends notification that the “rank” property has been added from the resource “Caesar” to the resource “Retired” (153), the “reports-to” dynamic taxonomy ignores this, and the “rank” dynamic taxonomy sends the notification that a child, “Caesar” was added to the parent “Retired” (154).

Similar notification, as shown by the rest of the sequence diagram in FIG. 15 is performed for the other four property changes. (155, 156, 157, and 158).

As will be appreciated among the activities described, a user of various embodiments of the invention will be able to:
define a new dynamic taxonomy utilizing domain rules,
query a domain model with a dynamic taxonomy,
modify a domain model with a dynamic taxonomy, and
modify a predefined dynamic taxonomy (i.e. changing what information it sees in the domain model or how it sees it).

In addition, the user may combine two or more of these bullet items, and each bullet item may be repeated several times. The user will be able perform any of the bullet items in any order as long as the first bullet item has been performed.

It should also be appreciated that the invention is not limited to the methods disclosed above, but also the apparatus required in the performance of the methods. Various exemplary means are disclosed below for the performance of steps of the methods of the invention.

An exemplary embodiment of the invention is an apparatus for managing information in a domain model. This exemplary apparatus includes, but is not limited to, a first means which utilizes at least one domain rule to define a dynamic taxonomy, and a second means which is utilized for extracting information from the domain model through the dynamic taxonomy. Additional embodiments of the apparatus of the invention may include a further means for viewing a representation of information extracted through the dynamic taxonomy. The means for viewing a representation of or extracting the information from the domain model may include a GUI or an API. Other exemplary embodiments of the apparatus of the invention may include a means for modifying some or all of the domain model in response to a change made through the dynamic taxonomy. Yet another exemplary embodiment of the apparatus of the invention includes a means to define at least two taxonomies with multiple domain rules, each of the taxonomies utilizing at least one domain rule that is also used for defining at least a second taxonomy. In this particular example, each of the multiple domain rules do not result in the same transformation. Information can be extracted through each of the dynamic taxonomies defined by the apparatus of the example. In addition, the apparatus of this example also could include a means for modifying some or all of the domain model through at least one of the dynamic taxonomies. Other exemplary embodiments of the apparatus of the invention may include means for utilizing multiple dynamic taxonomies to extract information from a domain model. The dynamic taxonomies of the invention also may be defined using at least one domain rule together with at least one dynamic taxonomy.

With respect to the various different embodiments of the apparatus of the invention, each of the means may well be the same hardware, differing only in the particular software being executed in connection therewith.

It should also be noted that each means of the exemplary embodiments of the apparatus of the invention and each step of the exemplary embodiments of the method of the invention are not necessarily confined to human users performing the steps or being a part of the means.

Those skilled in the art will have no difficulty devising myriad obvious improvements and variations, all of which are intended to fall within the scope of the invention as defined by the claims that follow.

1. A method for managing information in a domain model, the method comprising the steps of:
utilizing at least a first and second domain rule to define a first dynamic taxonomy;
utilizing at least a first and third domain rule to define a second dynamic taxonomy;
the first and second domain rules not resulting in the same transformation;
the second and third domain rules not resulting in the same transformation;
the first and third domain rules not resulting in the same transformation;
extracting information from the domain model through the first dynamic taxonomy; and
extracting information from the domain model through the second dynamic taxonomy.

2. The method of claim 1 further comprising the step of:
modifying some or all of the domain model by making changes through at least the first dynamic taxonomy.

3. A method for defining a dynamic taxonomy comprising the steps of:
defining at least one domain rule;
said at least one domain rule defining how a domain model is filtered and transformed;
said at least one domain rule validated to ensure logical consistency; and
persisting the at least one domain rule into a domain model.

4. The method of claim 3 wherein a user defines the at least one domain rule.

5. A method for managing information in a domain model, the method comprising the steps of:
utilizing at least one domain rule to define a dynamic taxonomy; and
extracting information from the domain model through the dynamic taxonomy.

6. The method of claim 5 further comprising:
modifying some or all of the domain model by making changes through the dynamic taxonomy.

7. The method of claim 5 wherein the information in the domain model comprises:
properties,
resources,
literals, and
statements.

8. The method of claim 5 wherein the step of extracting information from the domain model through the dynamic taxonomy utilizes a GUI.

9. The method of claim 5 wherein the step of extracting information from the domain model through the dynamic taxonomy utilizes an API.

10. The method of claim 5 further comprising the step of viewing a representation of the information extracted through the dynamic taxonomy.

11. The method of claim 6 wherein the information in the domain model comprises:
properties,
resources,
literals, and
statements.

12. The method of claim 10 wherein the step of viewing a representation of the information extracted through the dynamic taxonomy utilizes a GUI.

13. The method of claim 10 wherein the step of viewing a representation of the information extracted through the dynamic taxonomy utilizes an API.

14. A method for managing information in a domain model, the method comprising the steps of:
utilizing at least one domain rule to define a dynamic taxonomy; and
modifying some or all of the domain model by making changes through the dynamic taxonomy.

15. The method of claim 14 wherein the information in the domain model comprises:
properties,
resources,
literals, and
statements.

16. A method for managing information in a domain model, the method comprising the steps of:
at least one user utilizing at least one domain rule to define a dynamic taxonomy;
at least one user extracting information from the domain model through the dynamic taxonomy; and
at least one user viewing a representation of said information extracted through the dynamic taxonomy.

17. The method of claim 16 further comprising the step of:
at least one user modifying some or all of the domain model by making changes through the dynamic taxonomy.

18. A method for managing information in a domain model, the method comprising the steps of:
utilizing a first at least one domain rule to define a first dynamic taxonomy;
extracting information from the domain model through the first dynamic taxonomy;
utilizing a second at least one domain rule together with the first dynamic taxonomy to define a second dynamic taxonomy; and
extracting information from the domain model through the first and the second dynamic taxonomy.

19. A method for managing information in a domain model, the method comprising the steps of:
utilizing a first at least one domain rule to define a first dynamic taxonomy; and
modifying some or all of the domain model by making changes through the first dynamic taxonomy;
utilizing a second at least one domain rule together with the first dynamic taxonomy to define a second dynamic taxonomy; and
modifying some or all of the domain model by making changes through the second dynamic taxonomy.

20. An apparatus for managing information in a domain model, the apparatus comprising:
first means utilizing at least one domain rule to define a dynamic taxonomy; and
second means for extracting information from the domain model through the dynamic taxonomy.

21. The apparatus of claim 20 further comprising:
third means for viewing a representation of said information extracted through the dynamic taxonomy.

22. The apparatus of claim 20 wherein the second means for extracting information from the domain model through the dynamic taxonomy utilizes a GUI.

23. The apparatus of claim 20 wherein the second means for extracting information from the domain model through the dynamic taxonomy utilizes an API.

24. An apparatus for managing information in a domain model, the apparatus comprising:
first means utilizing at least one domain rule to define a dynamic taxonomy; and
second means responsive to changes made through the dynamic taxonomy, for modifying some or all of the domain model.

25. The apparatus of claim 24 further comprising:
third means for extracting information from the domain model through the dynamic taxonomy; and
fourth means for viewing a representation of said information extracted through the dynamic taxonomy.

26. An apparatus for managing information in a domain model, the apparatus comprising:
first means utilizing at least a first and second domain rule to define a first dynamic taxonomy;
second means utilizing at least a first and third domain rule to define a second dynamic taxonomy;
the first and second domain rules not resulting in the same transformation;
the second and third domain rules not resulting in the same transformation;
the first and third domain rules not resulting in the same transformation;
third means for extracting information from the domain model through the first dynamic taxonomy; and
fourth means for extracting information from the domain model through the second dynamic taxonomy.

27. The apparatus of claim 26 further comprising fifth means responsive to changes made through the first dynamic taxonomy, for modifying some or all of the domain model.

28. An apparatus for managing information in a domain model, the apparatus comprising:
first means for at least one user to utilize at least one domain rule to define a dynamic taxonomy;
second means for at least one user to extract the information from the domain model through the dynamic taxonomy; and
third means for at least one user to view a representation of said information extracted through the dynamic taxonomy.

29. The apparatus of claim 28 further comprising fourth means for at least one user to modify some or all of the domain model by making changes through the dynamic taxonomy.

30. An apparatus for managing information in domain model, the apparatus comprising:
first means utilizing a first at least one domain rule to define a first dynamic taxonomy;
second means for extracting information from the domain model through the first dynamic taxonomy;
third means utilizing a second at least one domain rule together with the first dynamic taxonomy to define a second dynamic taxonomy; and
fourth means for extracting information from the domain model through the first and second dynamic taxonomy.

31. An apparatus for managing information in a domain model, the apparatus comprising:
first means utilizing a first at least one domain rule to define a first dynamic taxonomy;
second means for modifying some or all of the domain model by making changes through the first dynamic taxonomy;
third means utilizing a second at least one domain rule together with the first dynamic taxonomy to define a second dynamic taxonomy; and
fourth means for modifying some or all of the domain model by making changes through the second dynamic taxonomy.
